(19) United States
(12) Patent Application Publication
(10) Pub. No.: US 2019/0017576 A1
(43) Pub. Date: Jan. 17, 2019

(54) POWER TRANSMISSION DEVICE

(71) Applicant: AISIN AW CO., LTD., Anjo-shi, Aichi-ken (JP)

(72) Inventors: Nobutada SUGIURA, Nishio (JP); Hiroaki SANJI, Takahama (JP); Shota OUE, Anjo (JP)

(73) Assignee: AISIN AW CO., LTD., Anjo-shi, Aichi-ken (JP)

(21) Appl. No.: 16/064,874

(22) PCT Filed: Feb. 17, 2017
(86) PCT No.: PCT/JP2017/005862

§ 371 Date: Jun. 21, 2018

(30) Foreign Application Priority Data
Feb. 18, 2016 (JP) 2016-028683

(51) Int. Cl. F16H 3/66; F16H 57/023

(52) U.S. Cl. CPC F16H 3/663; F16H 57/023; F16H 2200/003; F16H 2200/2046; F16H 3/666

(57) ABSTRACT

A center support (11c) having a sidewall part (111c) extending from an internal circumferential surface of a transmission case (11) toward a radial inner side of the transmission case (11); and a cylindrical part (112c) axially extending from an internal circumferential portion of the sidewall part (111c) is formed between a first drive gear (26) with a small diameter and a second drive gear (28) with a large diameter. The first drive gear (26) is turnably supported by a first bearing (31) on an internal circumferential surface of the cylindrical part (112c) of the center support (11c), and the second drive gear (28) is turnably supported by a second bearing (32) on an external circumferential surface of the cylindrical part (112c).

### CROSS REFERENCE TO RELATED APPLICATIONS

This application is a National Stage of International Application No. PCT/JP2017/005862 filed Feb. 17, 2017, claiming priority based on Japanese Patent Application No. 2016-028683 filed Feb. 18, 2016.

### TECHNICAL FIELD

Aspects of the present disclosure relate to a power transmission device.

### BACKGROUND ART

Conventionally, for this type of power transmission device, there is proposed a power transmission device in which three planetary gears, three clutches, two brakes, and two counter drive gears are disposed coaxially with an input shaft (see, for example, Patent Literature 1). Two counter driven gears provided on a countershaft which is an output shaft mesh with the two counter drive gears, respectively. As power transmission paths between the input shaft and the output shaft, the power transmission device has a power transmission path that transmits power inputted to one of the two counter drive gears to the countershaft, and a power transmission path that transmits power inputted to the other one of the two counter drive gears to the countershaft.

### CITATIONS LIST

### Patent Literature

Patent Literature 1: WO 2014/079642 A

### SUMMARY OF THE APPLICATION

In the above-described power transmission device, since the two counter drive gears are disposed coaxially with the input shaft in addition to the planetary gears, the clutches, and the brakes, and a support structure for the two counter gears is also required, axial length is increased.

It is an aspect of the present disclosure to reduce the axial length of a power transmission device.

The disclosure adopts the following manner to reduce the axial length of a power transmission device.

A power transmission device of the present disclosure is a power transmission device having a gear group disposed coaxially in a case, and transmitting power inputted to an input member to an output member via the gear group, the gear group including a first external tooth gear and a second external tooth gear with a larger diameter than the first external tooth gear, and the power transmission device includes:

a support member having a sidewall part and a hollow tubular part, and formed between the first external tooth gear and the second external tooth gear, the sidewall part extending from an internal circumferential surface of the case toward a radial inner side of the case, and the hollow tubular part axially extending from a radial inner side of the sidewall part;

a first bearing provided on an external circumferential surface of the tubular part and turnably supporting one of the first external tooth gear and the second external tooth gear; and

a second bearing provided on an internal circumferential surface of the tubular part and turnably supporting the other one of the first external tooth gear and the second external tooth gear.

In the power transmission device of the present disclosure, the support member having the sidewall part extending from the internal circumferential surface of the case toward the radial inner side of the case; and the hollow tubular part axially extending from the radial inner side of the sidewall part is provided between the first external tooth gear and the second external tooth gear with a larger diameter than the first external tooth gear. The first bearing is provided on the external circumferential surface of the tubular part to turnably support one of the first external tooth gear and the second external tooth gear, and the second bearing is provided on the internal circumferential surface of the tubular part to turnably support the other one of the first external tooth gear and the second external tooth gear. By this, the first bearing and the second bearing can be radially disposed, enabling to reduce the axial length of the power transmission device. In addition, the first bearing and the second bearing are disposed with the tubular part of the support member interposed therebetween, and one of the inner and outer rings of the bearings is fixed to the tubular part. Thus, an excessive difference in rotational speed does not occur between the inner and outer rings of the bearings, and a load on one of the bearings is not transmitted to the other. As a result, the load acting on the first bearing and the second bearing can be further reduced.

### BRIEF DESCRIPTION OF DRAWINGS

FIG. 1 is a schematic configuration diagram of a power transmission device according to an embodiment of the present disclosure.

FIG. 2 is an operation table showing a relationship between each gear of an automatic transmission 20 and the operating states of clutches and brakes.

FIG. 3 is a speed diagram showing a ratio of the rotational speed of each rotating element to the input rotational speed of the automatic transmission 20.

FIG. 4 is a cross-sectional view of a main portion of the power transmission device that includes a center support.

### DESCRIPTION OF EMBODIMENTS

Next, a mode for carrying out an aspect of the present disclosure will be described with reference to the drawings.

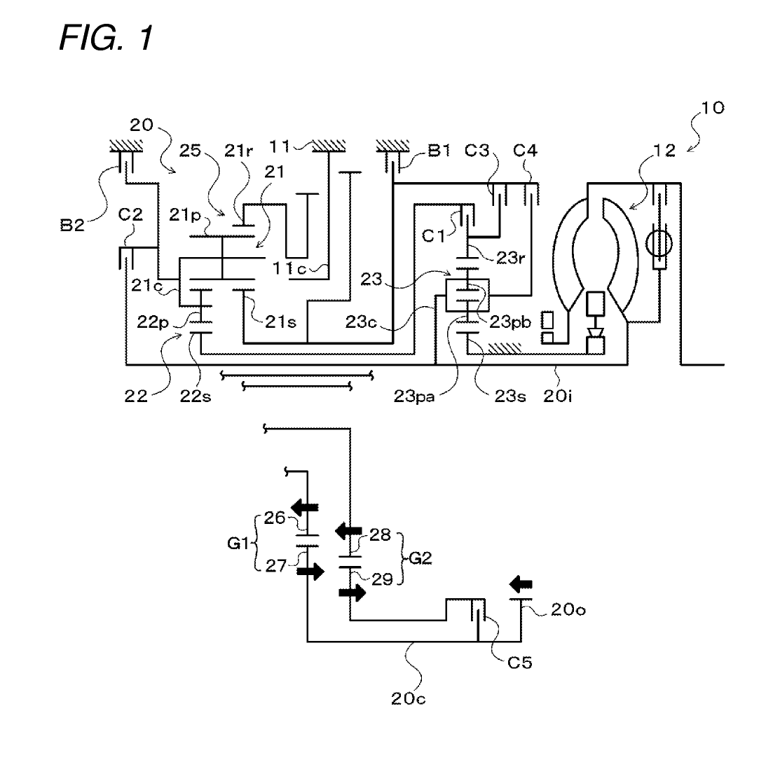

FIG. 1 is a schematic configuration diagram of a power transmission device 10 according to an embodiment of the present disclosure. As shown in FIG. 1, the power transmission device 10 is connected to a crankshaft for an engine EG (internal combustion engine) and/or a rotor of an electric motor, which are drive sources mounted transversely on a front portion of a front-wheel-drive vehicle and which are not shown, and can transmit power (torque) from the engine EG, etc., to left and right front wheels (drive wheels) which are not shown. As shown in the drawing, the power transmission device 10 includes a transmission case (stationary member) 11, a hydraulic power transmission (starting device) 12, etc., in addition to an automatic transmission 20 that changes gears to transmit power transmitted to an input shaft (input member) 20i from the engine EG, etc., to the front wheels of the vehicle.

As shown in FIG. 1, the hydraulic power transmission 12 is formed as a hydraulic torque converter with a lock-up clutch including a pump impeller, a turbine runner, a stator, a one-way clutch, a lock-up clutch, etc. Note that the hydraulic power transmission 12 may be a simple hydraulic coupling.

The automatic transmission 20 is formed as an 11-speed transmission. As shown in FIG. 1, the automatic transmission 20 includes, in addition to the input shaft 20i, an output gear (output member) 20o disposed on a countershaft (second shaft) 20c extending parallel to the input shaft (first shaft) 20i, a Ravigneaux planetary gear mechanism 25 which is a complex planetary gear mechanism formed by combination of a single-pinion first planetary gear 21 and a double-pinion second planetary gear 22, and a double-pinion third planetary gear 23. In the present embodiment, the output gear 20o is an externally toothed gear and is coupled to the left and right front wheels via a differential gear including a differential ring gear that meshes with the output gear 20o and a drive shaft (none of which are shown). In addition, in the present embodiment, the first and second planetary gears 21 and 22 forming the Ravigneaux planetary gear mechanism 25 and the third planetary gear 23 are disposed in the transmission case 11 such that the third planetary gear 23, the first planetary gear 21, and the second planetary gear 22 are arranged in this order from the starting device 12, i.e., the engine EG side (right side in FIG. 1).

The Ravigneaux planetary gear mechanism 25 has a first sun gear 21s and a second sun gear 22s which are externally toothed gears; a first ring gear 21r which is an internally toothed gear and is disposed concentrically with the first sun gear 21s; a plurality of first pinion gears (long pinion gears) 21p that mesh with the first sun gear 21s and the first ring gear 21r; a plurality of second pinion gears (short pinion gears) 22p that mesh with the second sun gear 22s and the plurality of first pinion gears 21p; and a first carrier 21c that rotatably (turnably) and revolvably holds the plurality of first pinion gears 21p and the plurality of second pinion gears 22p.

Such a first sun gear 21s, a first carrier 21c, first pinion gears 21p, and a first ring gear 21r of the Ravigneaux planetary gear mechanism 25 form the single-pinion first planetary gear 21. In addition, the second sun gear 22s, the first carrier 21c, the first and second pinion gears 21p and 22p, and the first ring gear 21r of the Ravigneaux planetary gear mechanism 25 form the double-pinion second planetary gear 22. In the present embodiment, the Ravigneaux planetary gear mechanism 25 is formed such that the gear ratio λ1 of the single-pinion first planetary gear 21 (the number of teeth on the first sun gear 21s/the number of teeth on the first ring gear 21r) is, for example, λ1=0.458 and the gear ratio λ2 of the double-pinion second planetary gear 22 (the number of teeth on the second sun gear 22s/the number of teeth on the first ring gear 21r) is, for example, λ2=0.375.

Furthermore, a first drive gear 26 which is an externally toothed gear is always coaxially coupled to the first ring gear 21r of the Ravigneaux planetary gear mechanism 25, and the first ring gear 21r and the first drive gear 26 always rotate or stop as one unit. Furthermore, a first driven gear 27 which is an externally toothed gear is always coaxially coupled to the output gear 20o of the automatic transmission 20. The first driven gear 27 meshes with the first drive gear 26, and always rotates or stops with the output gear 20o as one unit. The first drive gear 26 and the first driven gear 27 to which power is transmitted from the first drive gear 26 form a first gear train G1, and the first ring gear 21r functions as an output element of the Ravigneaux planetary gear mechanism 25.

In addition, a second drive gear 28 which is an externally toothed gear is always coaxially coupled to the first sun gear 21s of the Ravigneaux planetary gear mechanism 25, and the first sun gear 21s and the second drive gear 28 always rotate or stop as one unit. The second drive gear 28 forms, together with a second driven gear (externally toothed gear) 29 that meshes with the second drive gear 28, a second gear train G2. The second gear train G2 is formed such that its gear ratio gr2 (the number of teeth on the second driven gear 29/the number of teeth on the second drive gear 28) is different from the gear ratio gr1 of the first gear train G1 (the number of teeth on the first driven gear 27/the number of teeth on the first drive gear 26). In the present embodiment, the gear ratio gr1 of the first gear train G1 is gr1=1.00. In addition, the gear ratio gr2 of the second gear train G2 is set to be smaller than the gear ratio gr1 of the first gear train G1, and in the present embodiment gr2=0.870.

The third planetary gear 23 has a third sun gear (fixed element) 23s which is an externally toothed gear; a third ring gear (output element) 23r which is an internally toothed gear and is disposed concentrically with the third sun gear 23s; and a third carrier 23c (input element) that rotatably (turnably) and revolvably holds a plurality of pairs of two pinion gears 23pa and 23pb which mesh with each other and one of which meshes with the third sun gear 23s and the other one of which meshes with the third ring gear 23r. As shown in the drawing, the third sun gear 23s of the third planetary gear 23 is non-turnably connected (fixed) to the transmission case 11 via a support member (front support) which is not shown. In addition, the third carrier 23c of the third planetary gear 23 is always coupled to the input shaft 20i, and always rotates or stops with the input shaft 20i as one unit. By this, the third planetary gear 23 functions as a so-called reduction gear, and reduces speed to output power transmitted to the third carrier 23c which is an input element from the third ring gear 23r which is an output element. In the present embodiment, the gear ratio λ3 of the third planetary gear 23 (the number of teeth on the third sun gear 23s/the number of teeth on the third ring gear 23r) is, for example, λ3=0.487.

Furthermore, the automatic transmission 20 includes a clutch C1 (third engaging element), a clutch C2 (fourth engaging element), a clutch C3 (fifth engaging element), a clutch C4 (sixth engaging element), a brake B1 (first engaging element), a brake B2 (second engaging element), and a clutch C5 (output-side engaging element) for changing a power transmission path from the input shaft 20i to the output gear 20o.

The clutch C1 connects the third ring gear 23r of the third planetary gear 23 to the second sun gear 22s of the Ravigneaux planetary gear mechanism 25, and releases the connection therebetween. The clutch C2 connects the input shaft 20i to the first carrier 21c of the Ravigneaux planetary gear mechanism 25, and releases the connection therebetween. The clutch C3 connects the third ring gear 23r of the third planetary gear 23 to the first sun gear 21s of the Ravigneaux planetary gear mechanism 25, and releases the connection therebetween. The clutch C4 connects the third carrier 23c of the third planetary gear 23, i.e., the input shaft 20i, to the first sun gear 21s of the Ravigneaux planetary gear mechanism 25, and releases the connection therebetween.

The brake B1 non-turnably fixes (connects) the first sun gear 21s (first fixable element) of the Ravigneaux planetary gear mechanism 25 to the transmission case 11, and releases the fixation of the first sun gear 21s to the transmission case 11. The brake B2 non-turnably fixes (connects) the first carrier 21c of the Ravigneaux planetary gear mechanism 25 to the transmission case 11, and releases the fixation to the first carrier 21c. The first carrier 21c is non-turnably fixed to the transmission case 11. The clutch C5 connects the second driven gear 29 of the second gear train G2 to the output gear 20o (first driven gear 27), and releases the connection therebetween.

In the present embodiment, as the clutches C1, C2, C3, C4, and C5, a multi-plate friction hydraulic clutch (friction engaging element) having a hydraulic servo is adopted, the hydraulic servo including, for example, a piston, a plurality of friction engagement plates (a friction plate and a separator plate), and an engagement oil chamber and a centrifugal hydraulic pressure cancellation chamber, to each of which hydraulic oil is supplied. In addition, as the brakes B1 and B2, a multi-plate friction hydraulic brake (friction engaging element) having a hydraulic servo is adopted, the hydraulic servo including, for example, a piston, a plurality of friction engagement plates (a friction plate and a separator plate), and an engagement oil chamber to which hydraulic oil is supplied. The clutches C1 to C5 and the brakes B1 and B2 operate by the supply and discharge of hydraulic oil by a hydraulic control device which is not shown.

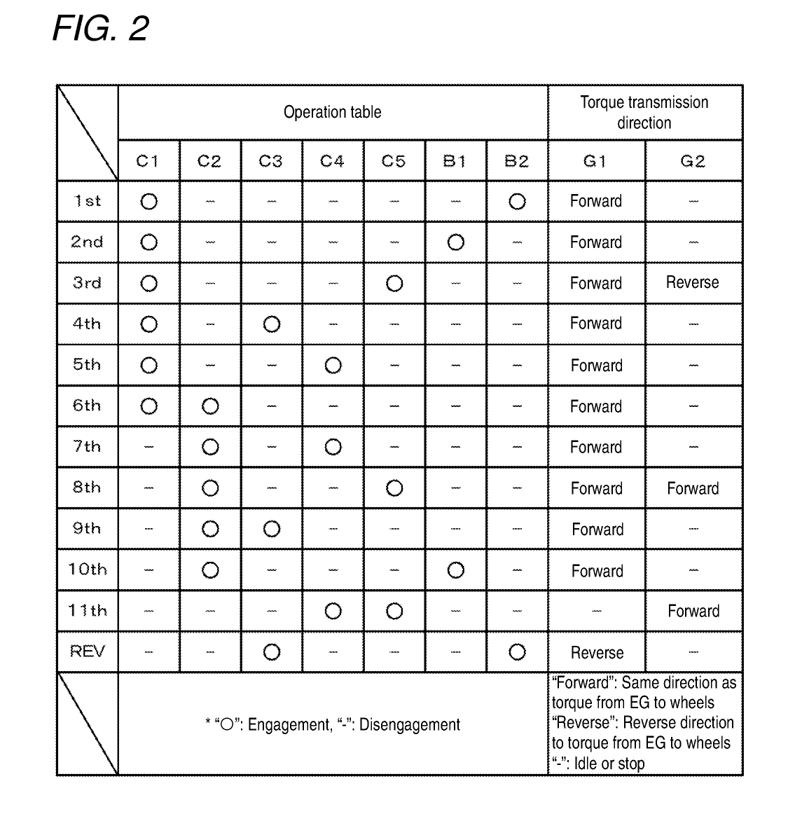

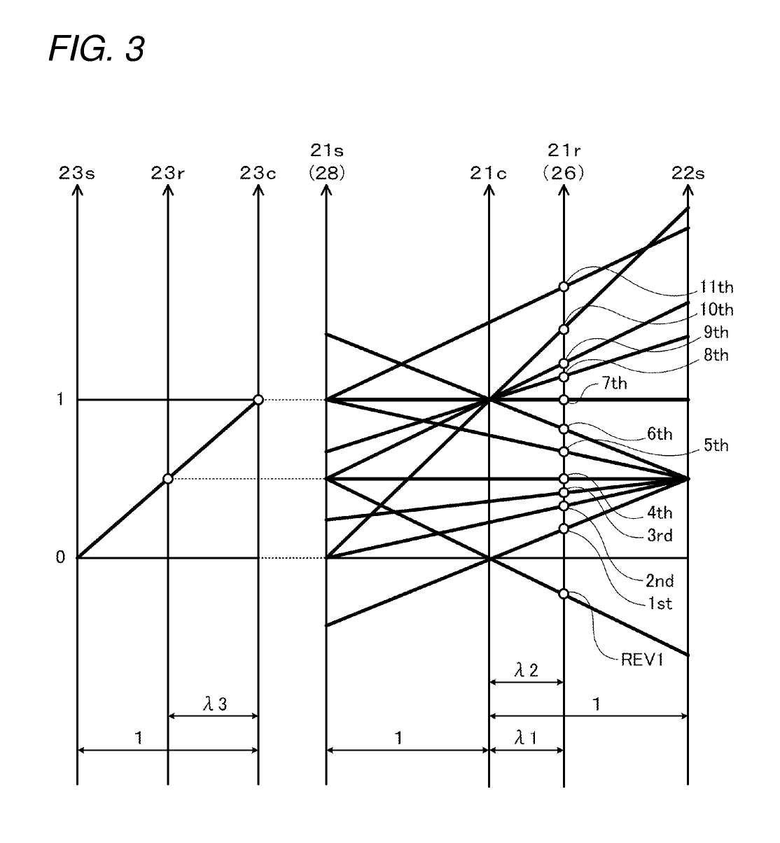

FIG. 2 is an operation table showing a relationship between each gear of the automatic transmission 20 and the operating states of the clutches C1 to C5 and the brakes B1 and B2, and FIG. 3 is a speed diagram showing a ratio of the rotational speed of each rotating element to the input rotational speed of the automatic transmission 20. Note that FIG. 2 shows the torque transmission directions of the first drive gear 26 and the second drive gear 28 for each gear, and “forward” in FIG. 2 indicates that the direction of torque transmission by the first drive gear 26 or the second drive gear 28 is the same as a direction in which torque is transmitted to the vehicle's wheels (front wheels) from the engine EG, and “reverse” indicates that the direction of torque transmission by the first drive gear 26 or the second drive gear 28 is reverse to the direction in which torque is transmitted to the vehicle's wheels (front wheels) from the engine EG. The automatic transmission 20 can set eleven power transmission paths in a forward rotation direction and one power transmission path in a reverse rotation direction, i.e., the first to eleventh forward gears and a reverse gear, between the input shaft 20i and the output gear 20o by engaging or disengaging the clutches C1 to C5 and the brakes B1 and B2 in the manner shown in FIG. 2. At this time, power inputted to the input shaft 20i (input member) is transmitted to the output gear 20o via any of the first gear train G1, the second gear train G2, and the first gear train G1 and the second gear train G2, according to the gear to be set. Specifically, as shown in FIG. 2, power inputted to the input shaft 20i (input member) is transmitted to the output gear 20o via the first gear train G1 for the first, second, fourth to seventh, ninth, and tenth forward gears and the reverse gear, transmitted to the output gear 20o via the second gear train G2 for the eleventh forward gear, and transmitted to the output gear 20o via the first gear train G1 and the second gear train G2 for the third and eighth forward gears. Namely, the first gear train G1 is a gear train in which torque transmission is performed for the first to tenth forward gears and the reverse gear, and the second gear train G2 is a gear train in which torque transmission is performed for the third, eighth, and eleventh forward gears. As such, in the first gear train G1 torque transfer is performed for almost all gears, and thus, the first gear train G1 has a larger number of gears in which torque transfer is performed and has a higher frequency of torque transmission, compared to the second gear train G2. In addition, in the first gear train G1, torque transmission is performed with low gears such as the first gear and the second gear, and thus, the first gear train G1 has larger transmission torque compared to the second gear train G2.

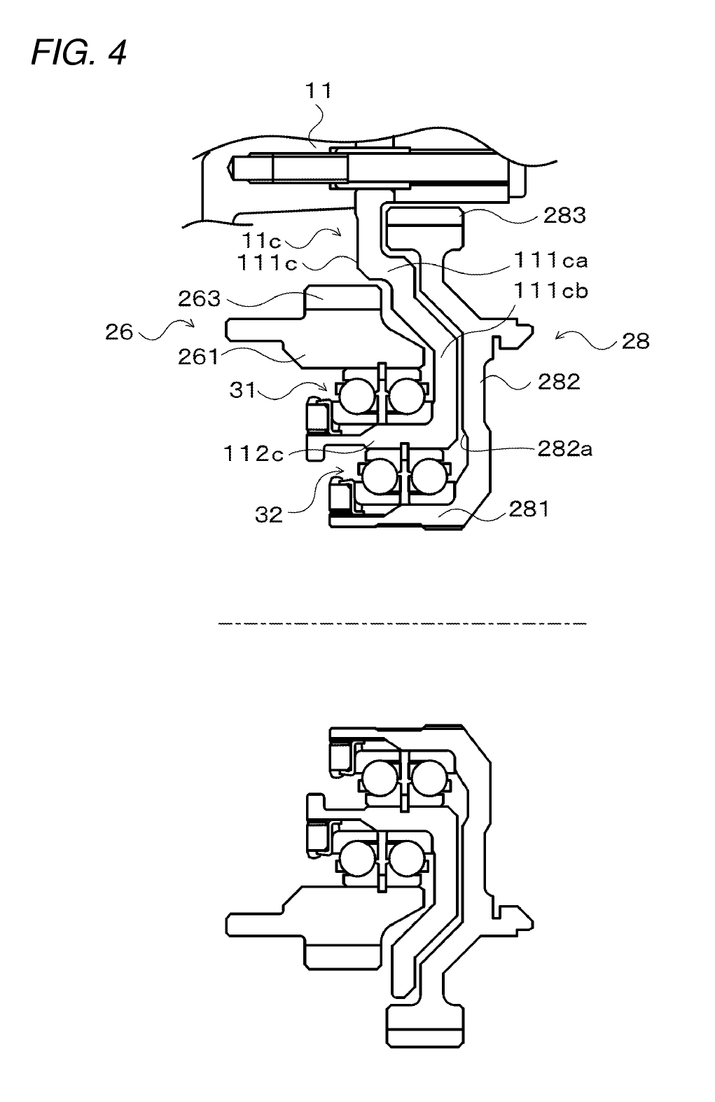

In addition, an annular center support (middle support part) 11c is fixed to the transmission case 11. The annular center support 11c is located between the first drive gear 26 and the second drive gear 28 and forms a part of the transmission case 11 (stationary member). FIG. 4 is a cross-sectional view of a main portion of the power transmission device that includes the center support. As shown in FIG. 4, the center support 11c has an annular sidewall part 111c extending from an internal circumferential surface of the transmission case 11 toward a radial inner side of the transmission case 11; and a cylindrical part 112c extending from an internal circumferential portion of the sidewall part 111c toward an axial side of the first drive gear 26 (the side of the Ravigneaux planetary gear mechanism 25) and having a central hollow made therein.

The first drive gear 26 has a first cylindrical part 261 disposed radially outwardly of and concentrically with the cylindrical part 112c of the center support 11c and having made therein a central hollow with a larger inside diameter than the outside diameter of the cylindrical part 112c; and a first external tooth part 263 formed on an external circumferential surface of the first cylindrical part 261. A first bearing 31 is interposed between the cylindrical part 112c (external circumferential surface) of the center support 11c and the first cylindrical part 261 (internal circumferential surface) of the first drive gear 26, and the first drive gear 26 (first cylindrical part 261) is turnably supported by the center support 11c (cylindrical part 112c) via the first bearing 31. Note that the first bearing 31 can be formed as, for example, a combined angular ball bearing that can accommodate radial loads and thrust loads in both directions. The first external tooth part 263 of the first drive gear 26 meshes with an external tooth part (not shown) of the first driven gear 27.

The second drive gear 28 has a second cylindrical part 281 disposed radially inwardly of and concentrically with the cylindrical part 112c of the center support 11c and having made therein a central hollow with a smaller outside diameter than the inside diameter of the cylindrical part 112c; an annular second sidewall part 282 extending from an axial end (the side of the third planetary gear 23) of the second cylindrical part 281 toward a radial outer side of the second cylindrical part 281; and a second external tooth part 283 formed on an external circumferential surface of the second sidewall part 282. A second bearing 32 is interposed between the cylindrical part 112c (internal circumferential surface) of the center support 11c and the second cylindrical part 281 (external circumferential surface) of the second drive gear 28, and the second drive gear 28 (second cylindrical part 281) is turnably supported by the center support 11c (cylindrical part 112c) via the second bearing 32. Note that the second bearing 32 can be formed as, for example, a combined angular ball bearing that can accommodate radial loads and thrust loads in both directions. The second sidewall part 282 of the second drive gear 28 has a substantially uniform thickness and is dented toward an axial side of the third planetary gear 23, and has a recess part 282a formed on a radial inner side of the second external tooth part 283, the recess part 282a opening on an axial side of the first drive gear 26 (the side of the Ravigneaux planetary gear mechanism 25). The second external tooth part 283 of the second drive gear 28 meshes with an external tooth part (not shown) of the second driven gear 29.

As such, the cylindrical part 112c of the center support 11c radially supports the first drive gear 26 by its external circumferential surface, and radially supports the second drive gear 28 by its internal circumferential surface. By this, the first bearing 31 and the second bearing 32 can be radially disposed, enabling to reduce the axial length of the power transmission device 10 compared to one in which the first bearing 31 and the second bearing 32 are axially disposed.

The gear ratio gr2 of the second gear train G2 including the second drive gear 28 and the second driven gear 29 is set to be smaller than the gear ratio gr1 of the first gear train G1 including the first drive gear 26 and the first driven gear 27, and the first external tooth part 263 of the first drive gear 26 is smaller in outside diameter than the second external tooth part 283 of the second drive gear 28.

The sidewall part 111c of the center support 11c has a curved part 111ca that is axially curved so as to enter a radial inner side (recess part 282a) of the second external tooth part 283 of the second drive gear 28 from a radial outer side of the first external tooth part 263 of the first drive gear 26; and a dented part 111cb on a radial inner side of the second external tooth part 283 of the second drive gear 28, the dented part 111cb having a substantially uniform thickness and dented along the dent shape of the second sidewall part 282 in the same direction. By this, the center support 11c can be disposed without providing extra space between the first external tooth part 263 and the second external tooth part 283, and thus, the axial length of the power transmission device 10 can be reduced. In addition, since the stiffness of the center support 11c (sidewall part 111c) is increased by the formation of the curved part 111ca, the radial deformation of the first drive gear 26 and the second drive gear 28 which are supported by the center support 11c (cylindrical part 112c) is suppressed, enabling to suppress the occurrence of noise or vibration.

As shown in FIG. 4, a part of the first cylindrical part 261 of the first drive gear 26 and a part of the first external tooth part 263 are disposed so as to enter a radial inner side of the curved part 111ca provided to the sidewall part 111c of the center support 11c, and the sidewall part 111c of the center support 11c has a notch part obtained by notching a part in a circumferential direction of the sidewall part 111c (see the bottom of the sidewall part 111c of FIG. 4). The first drive gear 26 meshes with the first driven gear 27 at the notch part. By thus allowing at least a part of the first drive gear 26 to enter the radial inner side of the curved part 111ca, the axial length can be further reduced. In addition, since the center support 11c is provided with the notch part and the first external tooth part 263 (first drive gear 26) meshes with the first driven gear 27 at the notch part, torque can be transmitted to the first driven gear 27 from the first drive gear 26 while the axial length is reduced.

In addition, as described above, since the first gear train G1 (first drive gear 26) has a higher torque transmission frequency and larger transmission torque compared to the second gear train G2 (second drive gear 28), the first bearing 31 supporting the first drive gear 26 requires higher load capacity compared to the second bearing 32 supporting the second drive gear 28. In the present embodiment, the first bearing 31 is disposed such that the first drive gear 26 is supported by the external circumferential surface (outside-diameter side) of the cylindrical part 112c of the center support 11c, and the second bearing 32 is disposed such that the second drive gear 28 is supported by the internal circumferential surface (inside-diameter side) of the cylindrical part 112c. Thus, the first bearing 31 (rolling elements) can be easily increased in diameter, enabling to ensure high load capacity.

Furthermore, the first bearing 31 is disposed such that the first drive gear 26 is supported by the external circumferential surface of the cylindrical part 112c of the center support 11c which is a stationary member, and the second bearing 32 is disposed such that the second drive gear 28 is supported by the internal circumferential surface of the cylindrical part 122c. Now, a configuration of a comparative example is considered in which a second bearing is disposed on an external circumferential surface of a cylindrical part of a center support (stationary member) to support an internal circumferential surface of a cylindrical part of a second drive gear by the second bearing, and a first bearing is disposed on an external circumferential surface of the cylindrical part of the second drive gear to support an internal circumferential surface of a cylindrical part of a first drive gear by the first bearing. As shown in FIGS. 2 and 3, in the first forward gear, the first drive gear 26 rotates forward with the transmission of a relatively large torque, and the second drive gear 28 idles in a reverse rotation direction to the first drive gear 26. Under such circumstances, in the configuration of the comparative example, since a large difference in rotational speed occurs between the inner and outer rings of the first bearing disposed between the first drive gear and the second drive gear, excessive load acts on the first bearing, which may cause a problem of durability of the first bearing. In addition, in the configuration of the comparative example, when the first bearing is subjected to a radial load by the meshing of the first driven gear and the first drive gear, the load is transmitted to the second bearing via the second drive gear. On the other hand, in the present embodiment, each of the inner ring of the first bearing 31 and the outer ring of the second bearing 32 is fixed to the cylindrical part 112c of the center support 11c which is a stationary member. Thus, a large difference in rotational speed does not occur between the inner and outer rings in both the first bearing 31 and the second bearing 32. In addition, since the tubular part 112c of the center support 11c is disposed between the first bearing 31 and the second bearing 32, a load acting on one of the first bearing 31 and the second bearing 32 is not transmitted to the other. By this, the load applied to the first bearing 31 and the second bearing 32 can be reduced.

In addition, in the present embodiment, the first drive gear 26 and the first driven gear 27 (first gear train G1) which mesh with each other, the second drive gear 28 and the second driven gear 29 (second gear train G2) which mesh with each other, the output gear 20o, and the differential ring gear which meshes with the output gear 20o each are formed of a helical gear. The gear helix directions of the first drive gear 26 and the first driven gear 27 are determined such that in a state in which the first drive gear 26 transmits torque in a forward direction (the same direction as the direction of torque transmitted to the wheels from the engine EG), thrust force acting on the countershaft 20c from the output gear 20o by the meshing of the output gear 20o and the differential ring gear and thrust force acting on the countershaft 20c from the first driven gear 27 by the meshing of the first drive gear 26 and the first driven gear 27 cancel each other out. Likewise, the gear helix directions of the second drive gear 28 and the second driven gear 29 are determined such that in a state in which the second drive gear 28 transmits torque in a forward direction, thrust force acting on the countershaft 20c from the output gear 20o by the meshing of the output gear 20o and the differential ring gear and thrust force acting on the countershaft 20c from the second driven gear 29 by the meshing of the second drive gear 28 and the second driven gear 29 cancel each other out. FIG. 1 shows, by filled arrows, the direction of thrust force acting on each of the first drive gear 26, the first driven gear 27, the second drive gear 28, the second driven gear 29, and the output gear 20o in the eighth forward gear. Note that, in the present embodiment, the tooth helix directions of the first driven gear 27 and the second driven gear 29 are the same as that of the output gear 20o. The tooth helix direction of the first drive gear 26 is opposite to that of the first driven gear 27, and the tooth helix direction of the second drive gear 28 is opposite to that of the second driven gear 29.

When the tooth helix direction of each gear is thus determined, in the first, second, fourth to seventh, ninth, and tenth forward gears, torque is transmitted to the countershaft 20c via the first gear train G1, and thrust force acting on the countershaft 20c from the output gear 20o and thrust force acting on the countershaft 20c from the first driven gear 27 have directions in which they cancel each other out. In addition, in the eleventh forward gear, torque is transmitted to the countershaft 20c via the second gear train G2, and thrust force acting on the countershaft 20c from the output gear 20o and thrust force acting on the countershaft 20c from the second driven gear 29 have directions in which they cancel each other out. Note that in the third forward gear and the eighth forward gear, torque is transmitted to the countershaft 20c via the first gear train G1 and the second gear train G2, and as shown in FIG. 2, in the third forward gear, the torque transmission direction of the first drive gear 26 (first driven gear 27) and the torque transmission direction of the second drive gear 28 (second driven gear 29) are opposite to each other, and in the eighth forward gear, the torque transmission direction of the first drive gear 26 (first driven gear 27) and the torque transmission direction of the second drive gear 28 (second driven gear 29) are the same. In this case, too, the configuration is such that thrust force acting on the countershaft 20c from the output gear 20o and thrust force acting on the countershaft 20c from the first driven gear 27 and the second driven gear 29 can cancel each other out. By thus setting the direction of thrust force acting on the countershaft 20c from each of the first driven gear 27, the second driven gear 29, and the output gear 20o such that they cancel each other out, the load applied to the first bearing 31 and the second bearing 32 can be reduced.

According to the power transmission device 10 of the present disclosure described above, the center support 11c having the sidewall part 111c extending from the internal circumferential surface of the transmission case 11 toward the radial inner side of the transmission case 11; and the cylindrical part 112c axially extending from the internal circumferential portion of the sidewall part 111c is formed between the first drive gear 26 with a small diameter and the second drive gear 28 with a large diameter. The first drive gear 26 is turnably supported by the first bearing 31 on the external circumferential surface of the cylindrical part 112c of the center support 11c, and the second drive gear 28 is turnably supported by the second bearing 32 on the internal circumferential surface of the cylindrical part 112c. By this, the first bearing 31 and the second bearing 32 can be radially disposed, enabling to reduce the axial length of the power transmission device 10 compared to one in which the first bearing 31 and the second bearing 32 are axially disposed.

In addition, according to the power transmission device 10 of the present disclosure, as the sidewall part 111c of the center support 11c, the curved part 111ca is provided, the curved part 111ca being axially curved so as to enter the radial inner side of the second external tooth part 283 of the second drive gear 28 from the radial outer side of the first external tooth part 263 of the first drive gear 26. By this, the center support 11c can be disposed without providing extra space between the first external tooth part 263 and the second external tooth part 283, and thus, the axial length of the power transmission device 10 can be reduced more. In addition, since the stiffness of the center support 11c is increased by the curved part 111ca, the radial deformation of the first drive gear 26 and the second drive gear 28 can be suppressed, enabling to suppress the occurrence of noise or vibration.

Although, in the above-described embodiment, one of the first drive gear 26 and the second drive gear 28 with a smaller diameter of the external tooth part (first drive gear 26) is supported by the external circumferential surface of the cylindrical part 112c of the center support 11c and a drive gear with a larger diameter of the external tooth part (second drive gear 28) is supported by the internal circumferential surface of the cylindrical part 112c, the drive gear with a smaller diameter of the external tooth part (first drive gear 26) may be supported by the internal circumferential surface of the cylindrical part 112c of the center support 11c and the drive gear with a larger diameter of the external tooth part (second drive gear 28) may be supported by the external circumferential surface of the cylindrical part 112c.

Although, in the above-described embodiment, as the sidewall part 111c of the center support 11c, the curved part 111ca is provided, the curved part 111ca being axially curved so as to enter the radial inner side of the second external tooth part 283 of the second drive gear 28 (large-diameter gear) from the radial outer side of the first external tooth part 263 of the first drive gear 26 (small-diameter gear), such a curved part 111ca may not be provided. Note, however, that, in this case, space corresponding to the thickness of the sidewall part 111c is required between the first external tooth part 263 of the first drive gear 26 and the second external tooth part 283 of the second drive gear 28.

As described above, a power transmission device of the present disclosure is a power transmission device (10) having a gear group disposed coaxially in a case (11), and transmitting power inputted to an input member (20i) to an output member (20o) via the gear group, the gear group including a first external tooth gear (26) and a second external tooth gear (28) with a larger diameter than the first external tooth gear (26), and the power transmission device (10) includes: a support member (11c) having a sidewall part (111c) and a hollow tubular part (112c), and formed between the first external tooth gear (26) and the second external tooth gear (28), the sidewall part (111c) extending from an internal circumferential surface of the case (11) toward a radial inner side of the case (11), and the hollow tubular part (112c) axially extending from a radial inner side of the sidewall part (111c); a first bearing (31) provided on an external circumferential surface of the tubular part (112c) and turnably supporting one of the first external tooth gear (26) and the second external tooth gear (28); and a second bearing (32) provided on an internal circumferential surface of the tubular part (112c) and turnably supporting the other one of the first external tooth gear (26) and the second external tooth gear (28).

Namely, in the power transmission device of the present disclosure, the support member (11c) having the sidewall part (111c) extending from the internal circumferential surface of the case (11) toward the radial inner side of the case (11) and the hollow tubular part (112c) axially extending from the radial inner side of the sidewall part (111c) is provided between the first external tooth gear (26) and the second external tooth gear (28), the first bearing (31) is disposed on the external circumferential surface of the tubular part (112c) to turnably support one of the first external tooth gear (26) and the second external tooth gear (28), and the second bearing (32) is disposed on the internal circumferential surface of the tubular part (112c) to turnably support the other one of the first external tooth gear (26) and the second external tooth gear (28). By this, the first bearing (31) and the second bearing (32) can be radially disposed, enabling to reduce the axial length of the power transmission device. In addition, the first bearing (31) and the second bearing (32) are disposed with the tubular part (112c) of the support member (11c) interposed therebetween, and one of the inner and outer rings of the bearings is fixed to the tubular part (112c). Thus, an excessive difference in rotational speed does not occur between the inner and outer rings of the bearings, and a load on one of the bearings is not transmitted to the other. As a result, the load acting on the first bearing (31) and the second bearing (32) can be further reduced.

In addition, it is also possible that the first external tooth gear (26) has a first annular part (261) having a first external tooth part (263) formed on its external circumferential surface, the second external tooth gear (28) has a second annular part (282) having a second external tooth part (283) formed on its external circumferential surface, the second external tooth part (283) having a larger diameter than the first external tooth part (263), the second annular part (282) of the second external tooth gear (28) has a recess part (282a) on a radial inner side of the second external tooth part (283), the recess part (282a) opening on an axial side of the first external tooth gear (26), and the sidewall part (111c) of the support member (11c) has a curved part (111ca) that is axially curved so as to enter the recess part of the second external tooth part (283) from a radial outer side of the first external tooth part (263). By this, the support member (11c) can be disposed without providing extra space between the first external tooth part (263) and the second external tooth part (283), and thus, the axial length of the power transmission device can be reduced more.

In this case, it is also possible that at least a part of the first external tooth gear (26) is disposed so as to enter a radial inner side of the curved part (111ca) of the support member (11c). By thus disposing the first external tooth gear such that at least a part of the first external tooth gear enters the radial inner side of the curved part, the axial length of the power transmission device can be further reduced. Furthermore, in this case, it is also possible that at least a part of the first external tooth part (263) of the first external tooth gear (26) is disposed on the radial inner side of the sidewall part (111c) of the support member (11c), a notch part is provided to a part in a circumferential direction of the sidewall part (111c) of the support member (11c), and the first external tooth gear (26) meshes with another external tooth gear (27) at the notch part, the other external tooth gear (27) transmitting torque to the output member (20o). By doing so, torque can be transmitted from the first external tooth gear to another external tooth gear while the axial length of the power transmission device is reduced.

Furthermore, it is also possible that the first external tooth gear (26) has an internal circumferential surface (261) on a radial outer side of the tubular part (112c) of the support member (11c), the internal circumferential surface (261) having an inside diameter larger than an outside diameter of the tubular part (112c), the second external tooth gear (28) has an external circumferential surface (281) on a radial inner side of the tubular part (112c) of the support member (11c), the external circumferential surface (281) having an outside diameter smaller than an inside diameter of the tubular part (112c), the first bearing (31) is provided between the internal circumferential surface (261) of the first external tooth gear (26) and the external circumferential surface of the tubular part (112c), and the second bearing (32) is provided between the external circumferential surface (281) of the second external tooth gear (28) and the internal circumferential surface of the tubular part (112c).

In addition, it is also possible that the gear group has a planetary gear (25) disposed coaxially with the input member (20i) and including a plurality of rotating elements, and the first external tooth gear (26) and the second external tooth gear (28) are coupled to different ones of the rotating elements of the planetary gear (25), and mesh with two external tooth gears (27 and 29), respectively, by which the power inputted to the input member (20i) is transmitted to the output member (20o) via the first external tooth gear (26) or the power inputted to the input member (20i) is transmitted to the output member (20o) via the second external tooth gear (28), the two external tooth gears (27 and 29) being disposed on different rotating shafts.

In addition, it is also possible that one (26) of the first external tooth gear (26) and the second external tooth gear (28) that is supported by the external circumferential surface of the tubular part (112c) via the first bearing (31) has a higher torque transmission frequency compared to the external tooth gear (28) supported by the internal circumferential surface of the tubular part (112c) via the second bearing (32). By doing so, the first bearing (31) that supports the external tooth gear (26) with a high torque transmission frequency is disposed on the outside-diameter side of the tubular part (112c), and the second bearing (32) that supports the external tooth gear (28) with a low torque transmission frequency is disposed on the inside-diameter side of the tubular part (112c). Thus, the first bearing (31) can be easily increased in diameter, enabling to ensure sufficient load capacity of the first bearing (31).

In addition, it is also possible that one (26) of the first external tooth gear (26) and the second external tooth gear (28) that is supported by the external circumferential surface of the tubular part (112c) via the first bearing (31) has larger transmission torque compared to the external tooth gear (28) supported by the internal circumferential surface of the tubular part (112c) via the second bearing (32). By doing so, the first bearing (31) that supports the external tooth gear (26) with large transmission torque is disposed on the outside-diameter side of the tubular part (112c), and the second bearing (32) that supports the external tooth gear (28) with small transmission torque is disposed on the inside-diameter side of the tubular part (112c). Thus, the first bearing (31) can be easily increased in diameter, enabling to ensure sufficient load capacity of the first bearing (31).

In addition, it is also possible that the output member (20o) is an output gear (20o) provided on a countershaft (20c) extending parallel to the input member (20i), the first external tooth gear (26) is a first drive gear (26) that meshes with a first driven gear (27) that transmits torque to the countershaft (20c), the second external tooth gear (28) is a second drive gear (28) that meshes with a second driven gear (29) that transmits torque to the countershaft (20c), the first drive gear (26), the first driven gear (27), the second drive gear (28), the second driven gear (29), and the output gear (20o) each are formed of a helical gear, the tooth helix directions of the first drive gear (26) and the first driven gear (27) are determined such that thrust force acting on the countershaft (22c) by the meshing of the first drive gear (26) and the first driven gear (27) and thrust force acting on the countershaft (22c) from the output gear (20o) cancel each other out, and the tooth helix directions of the second drive gear (28) and the second driven gear (29) are determined such that thrust force acting on the countershaft (20c) by the meshing of the second drive gear (28) and the second driven gear (29) and thrust force acting on the countershaft (20c) from the output gear (20o) cancel each other out. By doing so, the direction of thrust force acting on the countershaft (20c) from each of the first driven gear (27), the second driven gear (29), and the output gear (20o) is set such that they cancel each other out, by which the load applied to the first bearing (31) and the second bearing (32) can be reduced.

In addition, although the automatic transmission 20 can form the first to eleventh forward gears and a reverse gear, the automatic transmission 20 is not limited thereto, and the invention of the present disclosure can also be applied to an automatic transmission with any number of gears as long as the automatic transmission is provided with a gear group including two coaxial external tooth gears with different diameters.

Although the embodiment of the present disclosure is described above, aspects of the present disclosure is not limited to such an embodiment at all and can, of course, be implemented in various modes without departing from the spirit thereof.

### INDUSTRIAL APPLICABILITY

Aspects of the present disclosure are applicable to the manufacturing industry of power transmission devices, etc.

1. A power transmission device having a gear group disposed coaxially in a case, and transmitting power inputted to an input member to an output member via the gear group, the gear group including a first external tooth gear and a second external tooth gear with a larger diameter than the first external tooth gear, the power transmission device comprising:
a support member having a sidewall part and a hollow tubular part, and formed between the first external tooth gear and the second external tooth gear, the sidewall part extending from an internal circumferential surface of the case toward a radial inner side of the case, and the hollow tubular part axially extending from a radial inner side of the sidewall part;
a first bearing provided on an external circumferential surface of the tubular part and turnably supporting one of the first external tooth gear and the second external tooth gear; and
a second bearing provided on an internal circumferential surface of the tubular part and turnably supporting the other one of the first external tooth gear and the second external tooth gear.

2. The power transmission device according to claim 1, wherein
the first external tooth gear has a first annular part having a first external tooth part formed on an external circumferential surface of the first annular part,
the second external tooth gear has a second annular part having a second external tooth part formed on an external circumferential surface of the second annular part, the second external tooth part having a larger diameter than the first external tooth part,
the second annular part of the second external tooth gear has a recess part on a radial inner side of the second external tooth part, the recess part opening on an axial side of the first external tooth gear, and
the sidewall part of the support member has a curved part that is axially curved so as to enter the recess part of the second external tooth part from a radial outer side of the first external tooth part.

3-4. (canceled)

5. The power transmission device according to claim 1, wherein
the first external tooth gear has an internal circumferential surface on a radial outer side of the tubular part of the support member, the internal circumferential surface having an inside diameter larger than an outside diameter of the tubular part,
the second external tooth gear has an external circumferential surface on a radial inner side of the tubular part of the support member, the external circumferential surface having an outside diameter smaller than an inside diameter of the tubular part,
the first bearing is provided between the internal circumferential surface of the first external tooth gear and the external circumferential surface of the tubular part, and
the second bearing is provided between the external circumferential surface of the second external tooth gear and the internal circumferential surface of the tubular part.

6. The power transmission device according to claim 1, wherein
the gear group has a planetary gear disposed coaxially with the input member and including a plurality of rotating elements, and
the first external tooth gear and the second external tooth gear are coupled to different ones of the rotating elements of the planetary gear, and mesh with two external tooth gears, respectively, by which the power inputted to the input member is transmitted to the output member via the first external tooth gear or the power inputted to the input member is transmitted to the output member via the second external tooth gear, the two external tooth gears being disposed on different rotating shafts.

7. The power transmission device according to claim 1, wherein one of the first external tooth gear and the second external tooth gear that is supported by the external circumferential surface of the tubular part via the first bearing has a higher torque transmission frequency compared to the external tooth gear supported by the internal circumferential surface of the tubular part via the second bearing.

8. The power transmission device according to claim 1, wherein one of the first external tooth gear and the second external tooth gear that is supported by the external circumferential surface of the tubular part via the first bearing has larger transmission torque compared to the external tooth gear supported by the internal circumferential surface of the tubular part via the second bearing.

9. The power transmission device according to claim 1, wherein
the output member is an output gear provided on a countershaft extending parallel to the input member,
the first external tooth gear is a first drive gear that meshes with a first driven gear that transmits torque to the countershaft,
the second external tooth gear is a second drive gear that meshes with a second driven gear that transmits torque to the countershaft,
the first drive gear, the first driven gear, the second drive gear, the second driven gear, and the output gear each are formed of a helical gear,
tooth helix directions of the first drive gear and the first driven gear are determined such that thrust force acting on the countershaft by meshing of the first drive gear and the first driven gear and thrust force acting on the countershaft from the output gear cancel each other out, and
tooth helix directions of the second drive gear and the second driven gear are determined such that thrust force acting on the countershaft by meshing of the second drive gear and the second driven gear and thrust force acting on the countershaft from the output gear cancel each other out.

10. The power transmission device according to claim 2, wherein at least a part of the first external tooth gear is disposed so as to enter a radial inner side of the curved part of the support member.

11. The power transmission device according to claim 2, wherein
the first external tooth gear has an internal circumferential surface on a radial outer side of the tubular part of the support member, the internal circumferential surface having an inside diameter larger than an outside diameter of the tubular part,
the second external tooth gear has an external circumferential surface on a radial inner side of the tubular part of the support member, the external circumferential surface having an outside diameter smaller than an inside diameter of the tubular part,
the first bearing is provided between the internal circumferential surface of the first external tooth gear and the external circumferential surface of the tubular part, and
the second bearing is provided between the external circumferential surface of the second external tooth gear and the internal circumferential surface of the tubular part.

12. The power transmission device according to claim 11, wherein
the gear group has a planetary gear disposed coaxially with the input member and including a plurality of rotating elements, and
the first external tooth gear and the second external tooth gear are coupled to different ones of the rotating elements of the planetary gear, and mesh with two external tooth gears, respectively, by which the power inputted to the input member is transmitted to the output member via the first external tooth gear or the power inputted to the input member is transmitted to the output member via the second external tooth gear, the two external tooth gears being disposed on different rotating shafts.

13. The power transmission device according to claim 12, wherein one of the first external tooth gear and the second external tooth gear that is supported by the external circumferential surface of the tubular part via the first bearing has a higher torque transmission frequency compared to the external tooth gear supported by the internal circumferential surface of the tubular part via the second bearing.

14. The power transmission device according to claim 13, wherein one of the first external tooth gear and the second external tooth gear that is supported by the external circumferential surface of the tubular part via the first bearing has larger transmission torque compared to the external tooth gear supported by the internal circumferential surface of the tubular part via the second bearing.

15. The power transmission device according to claim 14, wherein
the output member is an output gear provided on a countershaft extending parallel to the input member,
the first external tooth gear is a first drive gear that meshes with a first driven gear that transmits torque to the countershaft,
the second external tooth gear is a second drive gear that meshes with a second driven gear that transmits torque to the countershaft,
the first drive gear, the first driven gear, the second drive gear, the second driven gear, and the output gear each are formed of a helical gear,
tooth helix directions of the first drive gear and the first driven gear are determined such that thrust force acting on the countershaft by meshing of the first drive gear and the first driven gear and thrust force acting on the countershaft from the output gear cancel each other out, and
tooth helix directions of the second drive gear and the second driven gear are determined such that thrust force acting on the countershaft by meshing of the second drive gear and the second driven gear and thrust force acting on the countershaft from the output gear cancel each other out.

16. The power transmission device according to claim 10, wherein
at least a part of the first external tooth part of the first external tooth gear is disposed on the radial inner side of the sidewall part of the support member,
a notch part is provided to a part in a circumferential direction of the sidewall part of the support member, and
the first external tooth gear meshes with another external tooth gear at the notch part, the other external tooth gear transmitting torque to the output member.

17. The power transmission device according to claim 16, wherein
the first external tooth gear has an internal circumferential surface on a radial outer side of the tubular part of the support member, the internal circumferential surface having an inside diameter larger than an outside diameter of the tubular part,
the second external tooth gear has an external circumferential surface on a radial inner side of the tubular part of the support member, the external circumferential surface having an outside diameter smaller than an inside diameter of the tubular part,
the first bearing is provided between the internal circumferential surface of the first external tooth gear and the external circumferential surface of the tubular part, and
the second bearing is provided between the external circumferential surface of the second external tooth gear and the internal circumferential surface of the tubular part.

18. The power transmission device according to claim 17, wherein
the gear group has a planetary gear disposed coaxially with the input member and including a plurality of rotating elements, and
the first external tooth gear and the second external tooth gear are coupled to different ones of the rotating elements of the planetary gear, and mesh with two external tooth gears, respectively, by which the power inputted to the input member is transmitted to the output member via the first external tooth gear or the power inputted to the input member is transmitted to the output member via the second external tooth gear, the two external tooth gears being disposed on different rotating shafts.

19. The power transmission device according to claim 18, wherein one of the first external tooth gear and the second external tooth gear that is supported by the external circumferential surface of the tubular part via the first bearing has a higher torque transmission frequency compared to the external tooth gear supported by the internal circumferential surface of the tubular part via the second bearing.

20. The power transmission device according to claim 19, wherein one of the first external tooth gear and the second external tooth gear that is supported by the external circumferential surface of the tubular part via the first bearing has larger transmission torque compared to the external tooth gear supported by the internal circumferential surface of the tubular part via the second bearing.

21. The power transmission device according to claim 20, wherein
the output member is an output gear provided on a countershaft extending parallel to the input member,
the first external tooth gear is a first drive gear that meshes with a first driven gear that transmits torque to the countershaft,
the second external tooth gear is a second drive gear that meshes with a second driven gear that transmits torque to the countershaft,
the first drive gear, the first driven gear, the second drive gear, the second driven gear, and the output gear each are formed of a helical gear,
tooth helix directions of the first drive gear and the first driven gear are determined such that thrust force acting on the countershaft by meshing of the first drive gear and the first driven gear and thrust force acting on the countershaft from the output gear cancel each other out, and
tooth helix directions of the second drive gear and the second driven gear are determined such that thrust force acting on the countershaft by meshing of the second drive gear and the second driven gear and thrust force acting on the countershaft from the output gear cancel each other out.
